(19) United States
(12) Patent Application Publication
(10) Pub. No.: US 2016/0125134 A1
(43) Pub. Date: May 5, 2016

(54) Automated Classification of Cells in Biologic Mixtures Analyzed by High Parameter Cytometry Instrumentation, Processing, System and Method

(71) Applicant: DeePath Medical, Inc., Palo Alto, CA (US)

(72) Inventors: Paul Kane, Tijeras, NM (US); Jita De, Palo Alto, CA (US)

(73) Assignee: DEEPATH MEDICAL, INC., Palo Alto, CA (US)

(21) Appl. No.: 14/931,794

(22) Filed: Nov. 3, 2015

Related U.S. Application Data
(60) Provisional application No. 62/074,232, filed on Nov. 3, 2014.

(51) Int. Cl. G06F 19/24

(52) U.S. Cl. CPC G06F 19/24

(57) ABSTRACT

A processing, system and method for automated classification of cells in biologic mixtures analyzed by high parameter cytometry instrumentation is disclosed. A signal processor is configured to automatically pre-process the data from a mass cytometer configured to process data marked into a number of channels in a manner that enables subsequent automated classification, clustering and profiling of defined cell types. The method comprises performing the steps of identifying, computing and replacing event values marked into a given marker channel from the mass cytometer,

### CROSS-REFERENCES TO RELATED APPLICATIONS

This application claims priority to U.S. patent application Ser. No. 62/074,232, filed on 3 Nov. 2014, the full disclosure of which is incorporated herein by reference.

### FIELD OF THE INVENTION

The present invention is related to systems, processors, devices and methods for the analysis and classification of cell types based on distinguishing phenotypes. More specifically, it relates to novel methods to address the challenges associated with processing and analyzing the data derived from new cytometry technology, exemplified by mass cytometry such as the CyTOF system (Fluidigm/DVS Sciences).

### DESCRIPTION OF THE RELATED ART

Mainstream single-cell cytometry is based on flow cytometry technology and is tedious, technologist intensive and subjective. In both flow cytometry and mass cytometry, instruments are designed to measure the degree to which individual cells express specific antigens or markers as assessed by antibody capture. Antibodies with specific antigen-binding capacity are tagged with a reporter molecule which can be detected by the instrument to quantify the amount of each antigen expressed by each cell analyzed. In the case of flow cytometers, fluorochromes with specific excitation/emission characteristics are used as reporters and detected by optical spectroscopy methods.

In mass cytometry, rare earth and other elements not found in nature are used as reporters and detected by mass spectroscopy methods. The manual analysis methods are performed by sequential selection of cells into narrower gates using bivariate dot plots till the most pure populations can be derived with a set of markers tested in an experiment. The expression level of markers can be described as positive (+), negative (−), dim (+/− or +), and bright (++). In general, expression of a set of cluster designation (cluster of designation or classification determinant) markers is used to distinguish cell types. The expression profile of CD markers defines the cell and can be used to identify abnormal cell types (such as leukemic blasts, hairy cell leukemia cells, and clonal cells of certain lymphomas). Cells can also be delineated by differences in intracellular biologic features that can correlate with certain surface CD markers.

There are several important differences in the capabilities of the two cytometer technologies. The number of markers that can be used for detection in diagnostic flow cytometry instruments is limited to approximately 10, with little promise of expansion. Mass cytometry can currently handle 40 and the number is expected to increase to 100. Concurrent measurements of ≧40 markers on each cell allow cells to be delineated based on their lineage and maturation status, and certain intracellular biologic features such as proliferation rate. Using the appropriate distinguishing markers, this allows more than 20 cellular subsets to be readily identified in a typical biologic mixture such as peripheral blood or bone marrow.

The statistical distributions of the expression data for a given marker across all cells analyzed are highly irregular and in their raw form do not lend themselves to statistical analysis nor to manual graphical analysis. These data distributions tend to be reasonably modeled by a log-normal distribution at the higher event count levels although often it is multimodal. Accordingly, it is standard practice to transform the data by taking the logarithm of the event counts. However this is problematic for events that at the lower end of the dynamic range including negative or zero values for which the real valued logarithm is not defined. Several algorithmic transformation methods are available in which the general approach is to represent the low values, including zero and negative values linearly and change to a logarithmic method. Thus pre-processing (transformation) methods are applied as follows: Logicle, biexponential, arcsinh, hyperlog, FloJo proprietary transformation.

In flow cytometry (FCM)-based diagnostics, leukocyte subtyping is achieved by labeling the sample with the appropriate set of antibodies to distinguish cell types by their lineage and maturation status. Neoplastic populations are identified by clonal expansion of cells defined by antigenic aberrancies when compared to their normal counterparts. Despite multi-parameter capabilities of FCM, a general lack of the ability to measure functional attributes precludes identification of cells based on their oncogenic potential and deregulated proliferative pathways. Inclusion of markers of signaling activities in a multiplexed cytometry assay has the potential to more precisely identify neoplastic subsets, particularly when differences in the static antigens compared to normal cells are minimal for the markers tested.

### SUMMARY OF THE INVENTION

Described herein are systems, processors, devices and methods for the analysis and classification of cell types based on distinguishing phenotypes.

In one aspect, a signal processor configured to automatically pre-process the data from a mass cytometer configured to process data marked into a number of channels. The processor enables subsequent automated classification, clustering and profiling of defined cell types. In one aspect, the processor follows a method for event values marked into a given marker channel from the mass cytometer.

In one aspect the method involves identifying event values equal to or below a threshold value. The method comprises computing the mean and standard deviation of the identified event values. The method uses the computed mean and standard deviation to define a statistical distribution. In some aspects, the statistical distribution may comprise data greater than zero.

The method replaces the event values equal to or below the threshold value in the marker channel with values drawn from the statistical distribution. In some embodiments, the replacement is not performed if a number of the event values is less than 3. The method repeats the steps a) through d) for the entire data set comprising the number of channels. In one aspect, the statistical distribution is one of a Rician distribution, a Gaussian distribution, a Rayleigh distribution or a Student's t-distribution.

Other aspects of the invention including corresponding systems, processors, devices and methods are described herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 illustrates a method of classifying mass cytometry data according to one embodiment of the invention.

FIGS. 2A-2D show raw data histograms for a set of marker data from a mass cytometry processing run, FIGS. 2A, 2B, 2C and 2D correspond to CD45tot, CD45RA, CD16 and CD66tot, respectively.

FIGS. 3A-3D show raw data histograms for a set of marker data from the low valued range of the data shown in FIGS. 2A-2D, FIGS. 3A, 3B, 3C and 3D correspond to CD45tot, CD45RA, CD16 and CD66tot, respectively.

FIG. 4 shows plots of the probability density function of the Rician distributions based on the data illustrated in FIGS. 2A-D and FIGS. 3A-D.

FIGS. 5A-5D show histograms of the transformed data after drawing low valued replacement from distributions illustrated in FIG. 4, FIGS. 5A, 5B, 5C and 5D correspond to CD45tot, CD45RA, CD16 and CD66tot, respectively.

FIG. 6 shows expression profile of surface markers and select IC signaling effectors in 36 CD34+ CML cells identified by automated algorithms.

FIG. 7 shows Spearman's rank correlation of select proteins in the CD34+ CML progenitor cells classified by statistical pattern recognition applying the disclosed auto-classifier method.

FIG. 8 show Spearman's rank correlation of select proteins for the CD3+ lymphoid PCs classified by statistical pattern recognition applying the disclosed auto-classifier method.

FIG. 9 shows signaling activation profile of CD34+ CML cells, and the CD19 and CD3 lymphoid PCs.

FIG. 10 shows confusion matrix for event classification by the disclosed method using manual sequential gating results for training the algorithms.

FIG. 11 illustrates cell type-specific protein expression profile shows that in contrast to mature T cell subsets, the CD19 and CD3 lymphoid PCs have high IC signaling activities with virtually identical elevated levels of STAT5 and STAT3 activities, concurrent with IL-7R expression

FIG. 12 illustrates comparative protein expression profiling of select receptor and IC phosphoproteins and the relative proportions of all the cell types are represented by the circle of the diameter.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The word “exemplary” is used herein to mean “serving as an example, instance, or illustration.” Any implementation described herein as “exemplary” is not necessarily to be construed as advantageous over other implementations.

Although the detailed description contains many specifics, these should not be construed as limiting the scope of the invention but merely as illustrating different examples and aspects of the invention. It should be appreciated that the scope of the invention includes other embodiments not discussed herein. Various other modifications, changes and variations which will be apparent to those skilled in the art may be made in the arrangement, operation and details of the system and method of the present invention disclosed herein without departing from the spirit and scope of the invention as described here.

The proposed invention relating to systems, processors, devices and methods for the analysis and classification of cell types based on distinguishing phenotypes is further described with reference to the sequentially numbered figures.

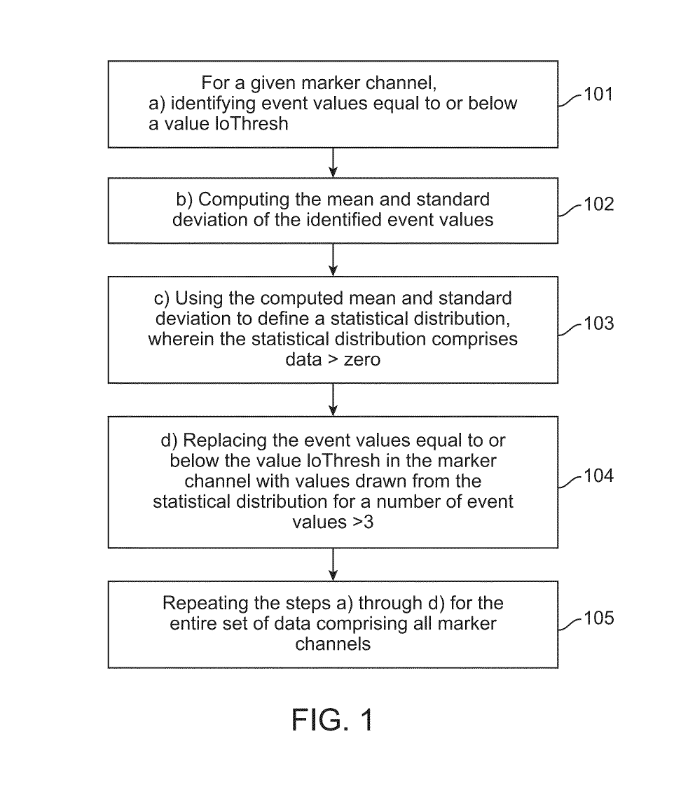

In one embodiment, the invention discloses a signal processor configured to automatically pre-process the data from a mass cytometer configured to process data marked into a number of channels. The processor enables subsequent automated classification, clustering and profiling of defined cell types. In one embodiment, the processor follows a method for event values marked into a given marker channel from the mass cytometer as shown in FIG. 1.

In one embodiment the method involves identifying event values equal to or below a threshold value in step 101. In one embodiment, the method comprises computing the mean and standard deviation of the identified event values in step 102. In the step 103, the method uses the computed mean and standard deviation to define a statistical distribution. In some embodiments, the statistical distribution may comprise only data greater than zero.

In step 104, the method replaces the event values equal to or below the threshold value in the marker channel with values drawn from the statistical distribution computed in step 103. In some embodiments, the replacement is not performed if a number of the event values is less than 3. In various embodiments, the method repeats the steps 101 through 104 for the entire data set comprising the entire number of channels from the mass cytometer in step 105.

The approach to transform the data for events having low count values according to various embodiments consists of the following steps which are performed independently for each marker channel. In some embodiments the threshold value in step 101 is specified by a parameter reflecting the operating characteristics of the mass cytometer. In one example, for the Fluidigm/DVS Sciences CyTOF system it is set to 5 but may be any other value typically in the range from 3 to 10. Step 101 in some embodiments further comprises identifying all the event values equal to or below the threshold value. In one embodiment, if there are fewer than three such values, that channel is flagged for special handling as it is not practical to form statistical estimates on the corresponding data.

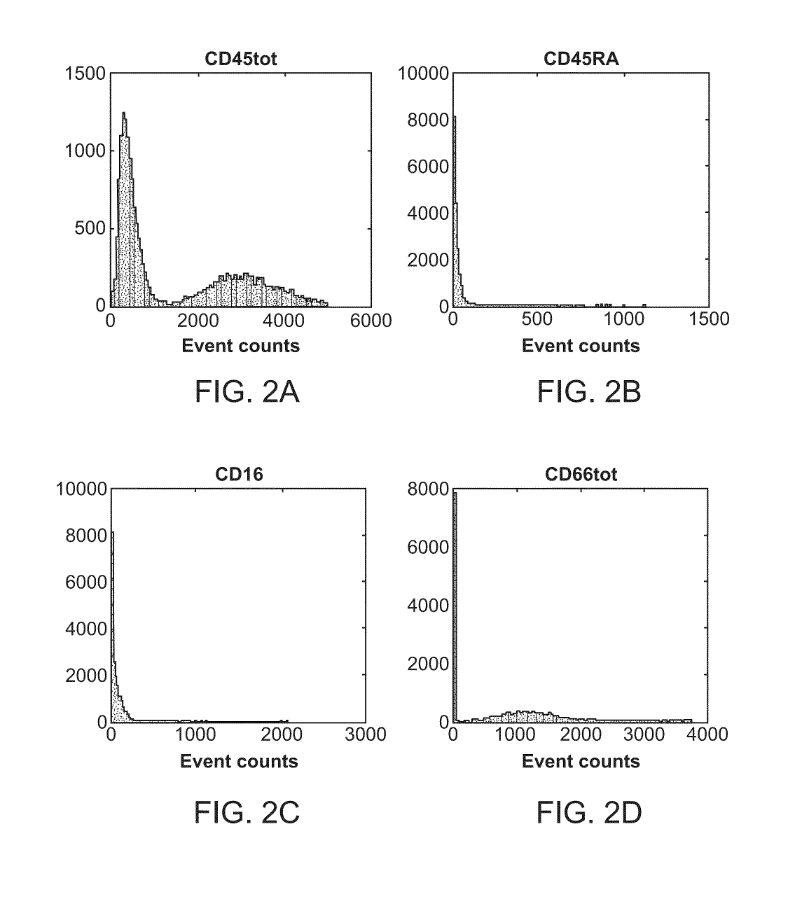

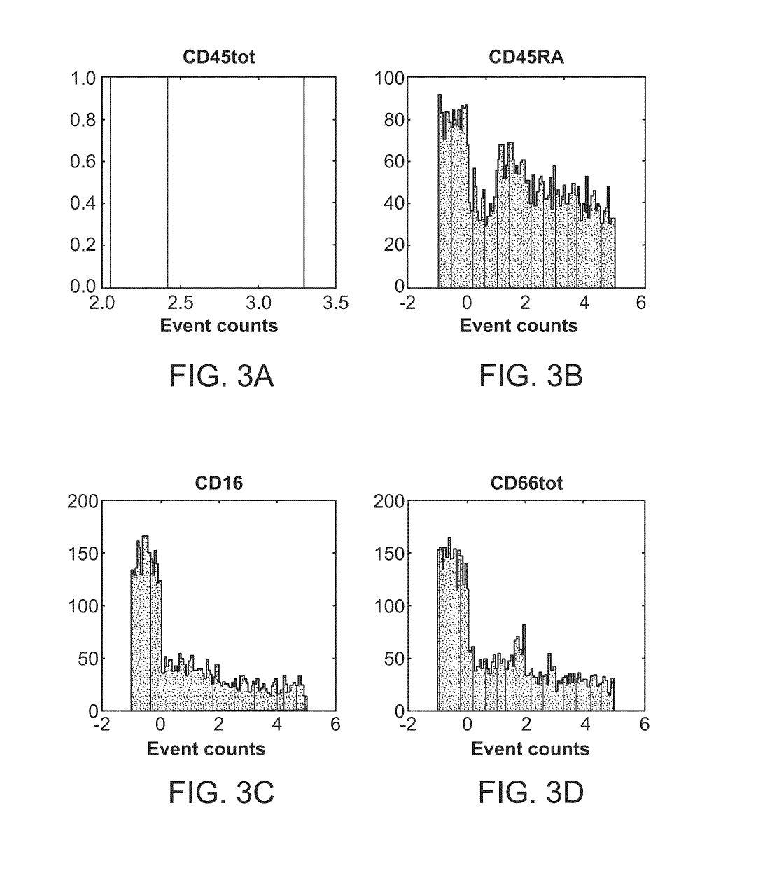

Exemplary raw data histograms for a set of marker data from a mass cytometry processing run according to step 101 is illustrated in FIGS. 2A to 2D, while FIGS. 3A to 3D show the corresponding histograms limited to the low valued portion. In some aspects of the disclosure, these low values may represent 25 percent of the total data points for a channel while in others they may range as high as 80 percent.

In some embodiments of step 103, the computed mean and standard deviation parameters are used to define a statistical distribution from which replacement values will be drawn. In one embodiment the replacement data satisfy the constraint of being greater than zero. In some embodiments a further constraint on the lower value is imposed as 0.1. In some embodiments in step 103, additional constraint is imposed on the upper limit of the replacement value. In one embodiment, it is set to the same as the threshold value. In some embodiments the tail of the distribution from which replacement values are drawn is trimmed so that no low values, which represent negative antigen expression, are replaced with values which might fall into the “dim” or positive antigen expression range. In some embodiments, these constraints in step 103 are implemented by using truncated distributions.

In various embodiments the method in step 103 uses a statistical distribution such as Rician distribution, Gaussian, Rayleigh or Student's t-distribution. In one embodiment the statistical distribution and constraints are selected to reduce the likelihood of encountering ill-conditioned matrices in subsequent statistical operations and to facilitate subsequent multivariate nonparametric modeling operations.

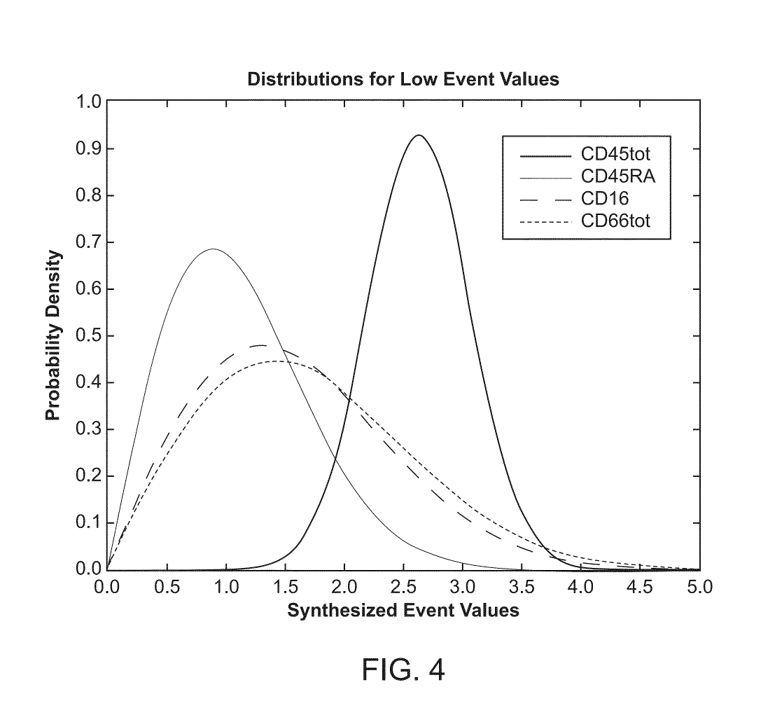

In one exemplary embodiment the sample mean of the low valued data in step 103 is used as the noncentrality parameter for the Rician distribution. In one embodiment the sample standard deviation is scaled by a factor of 0.75 and used as the sigma parameter of the Rician distribution. In some embodiments in step 103 the statistical distribution is a truncatable Rician distribution with truncation parameters that define the minimum and maximum constraints of 0.1 and the threshold value, respectively. In one exemplary embodiment, FIG. 4 illustrates plots of the probability density function (pdf) of the Rician distributions based on the data illustrated in FIGS. 2A-2D and 3A-3D.

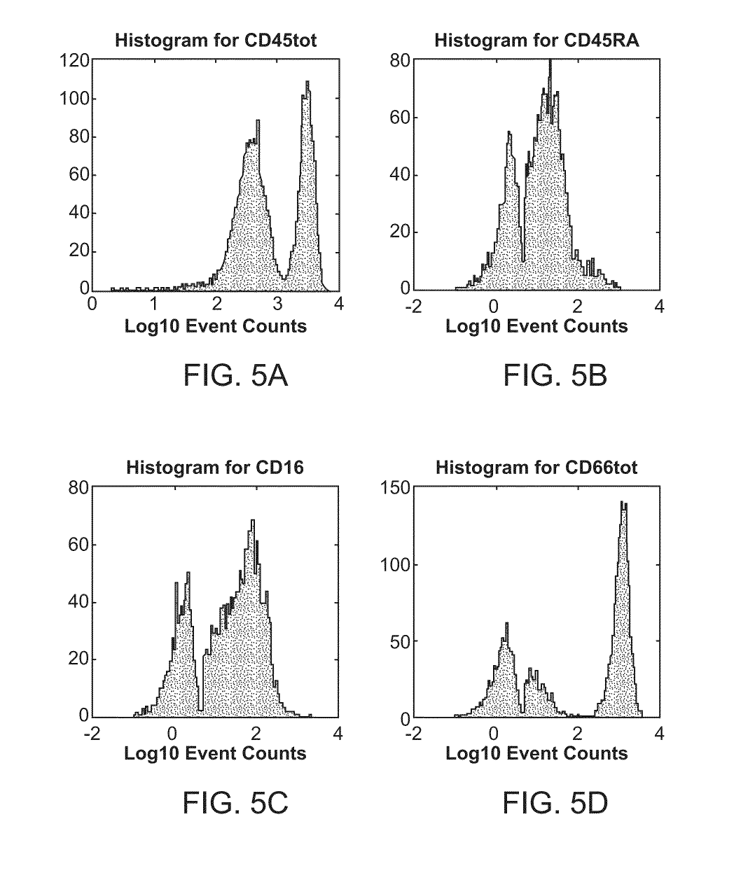

In various embodiments in step 104 the low valued data below the threshold identified in step 101 in each marker channel are replaced with values drawn from the distributions as described above, provided the values number greater than 3. In one embodiment, no replacement is performed if there were less than three low values associated with a given vector or cell event. In one embodiment, a logarithmic (base 10) transformation is also performed on the transformed data. Exemplary transformed data corresponding to FIGS. 3A-D are shown in FIGS. 5A-D after the low value replacement and logarithmic transformation.

The invention is further illustrated with reference to the following examples, which however, are not to be construed to limit the scope of the invention, as delineated in the appended claims.

### EXAMPLES

### Example 1

### Computing the Probability Distribution Function

For the purpose of illustrating the various embodiments of the invention, an example of MATLAB script code used to define and display the subject probability distributions in step 103 if FIG. 1 is shown below.

```
%Preprocess MB25 gated data separately for each marker channel to be
used.
% Perform operation to make low valued data Rician distributed.
% Calculate the mean and std for the low values of each channel to
support
% creating the distribution model.
for i=1:numCh; % For each marker channel
  ixLo = find(featVecs(:,i) <= loThresh);
  numLo = numel(ixLo);
  if numLo < 3;
    musig(i,1:2) = 0.0; % Flag for special handling
  else
    musig(i,1) = mean(featVecs(ixLo,i)); % noncentrality parameter for
    Rician
    musig(i,1) = max(musig(i,1),0.1);
    musig(i,2) = std(featVecs(ixLo,i)) * 0.75; % scaled down standard
    deviation
  end
end
% For each channel, create a truncatable Rician distribution object from
which
% low values will be drawn. This will be an array of PDF objects
x = 0:.1:5; % for plotting
clear pd tpd
figure(203);
for i = 1:numCh;
  if musig(i,1) ~= 0;
    pd(i) = makedist(‘Rician’,‘s’,musig(i,1),‘sigma’,musig(i,2));
    mu = musig(i,1); % For code readability
    sig = musig(i,2);
    %tpd(i) = truncate(pd(i),mu−3*sig,mu+3*sig); % Limit to +− 3
    sigma about mu
    tpd(i) = truncate(pd(i),0.1,loThresh); % Apply low and high
    constraints
    plot(x,pdf(tpd(i),x));% plot each pdf for checkout
    hold on
  end
end
hold off
legend(featNames)
title(‘Distributions for Low Event Values’,‘FontSize’, [12],‘FontWeight’,
‘bold’);
ylabel(‘Probability Density’,‘FontSize’, [11],‘FontWeight’,‘bold’)
xlabel(‘Synthesized Event Values’,‘FontSize’, [12],‘FontWeight’,‘bold’)
```

### Example 2

### Low Value Replacement

Example MATLAB script code to perform the low value replacement according to step 104 of FIG. 1 and create the display of FIGS. 5A-5D is shown below.

```
% For each channel scan through the events, replacing low values as
described.
% Follow this with the logarithmic transformation and create tiled
histogram display.
figure(301)
set(gcf, ‘position’, [2031 273 1126 770]);
ixAll = 1:size(featVecs,1); % Indicies of all featVecs
for i = 1:numCh;
  subplot(3,4,i); % changed for profiling, (3,4,i) for classification
  if musig(i,1) ~= 0; % Skip if there were < 3 low count values
    ixLo = find(featVecs(:,i) <= loThresh); % Indices of vectors needing
    replacement
    ixHi = setdiff(ixAll,ixLo)’; % Incices of vectors to be left unchanged
    numLo = numel(ixLo); % Number of low values to be replaced
    rands = random(tpd(i),numLo,1); % Draw required number of values
                  from % truncated probability distribution
    for j = 1:numLo
      ix = ixLo(j);
      featVecsT(ix,i) = rands(j);
    end
    featVecsT(ixHi,i) = featVecs(ixHi,i);
    featVecsT(:,i) = log10(featVecsT(:,i));
    hist(featVecsT(:,i),1000);
    title([‘Histogram for ’ featNames{i}],‘FontSize’,12,‘FontWeight’,
    ‘demi’);
    xlabel(‘Log10 Event Counts’)
  else
    featVecsT(:,i) = log10(featVecs(:,i));
    hist(featVecsT(:,i),1000)
    title([‘Histogram for ’ featNames{i}],‘FontSize’,12,‘FontWeight’,
    ‘demi’);
    xlabel(‘Log10 Event Counts’)
  end
end
hmt300 = mtit(‘Histograms of transformed marker values’); % Apply title
set(hmt300.th,‘Position’ ,[.5 1.045 0],‘FontSize’, [12],‘FontWeight’,
‘bold’);
```

The mass cytometry data as transformed above may now be used directly in subsequent Eyelis processing and analysis steps such as robust statistical classification techniques to support automatic cell identification and profiling.

### Example 3

Cell-Based Assay for Residual/Relapsed Disease Detection in Chronic Myelogenous Leukemia

Patient History: A 74-year-old male patient was previously treated with imatinib (IM) for 8 years for chronic-phase CML. Two months prior to this blood sampling (obtained with informed consent), the patient switched to a second-generation (2G) TKI, which he subsequently discontinued due to side effects. The patient presented with a rapidly rising BCR-ABL:ABL ratio of 0.285, and normal blood counts: WBC of 7.9 K/ml (neutrophils 3.43 K/μL, lymphs 3.41 K/μL, monocytes 0.82 K/μL, eosinophils 0.23 K/μL, basophils 0.03 K/μL), Hgb 14.1 g/dL, platelets 177 K/μL. Once the treatment was resumed, the BCR-ABL transcript trended down to undetectable. Except for a slight increase in the lymphocyte count upon treatment resumption (3.41 to 3.77 K/ml), the follow-up blood counts were unremarkable.

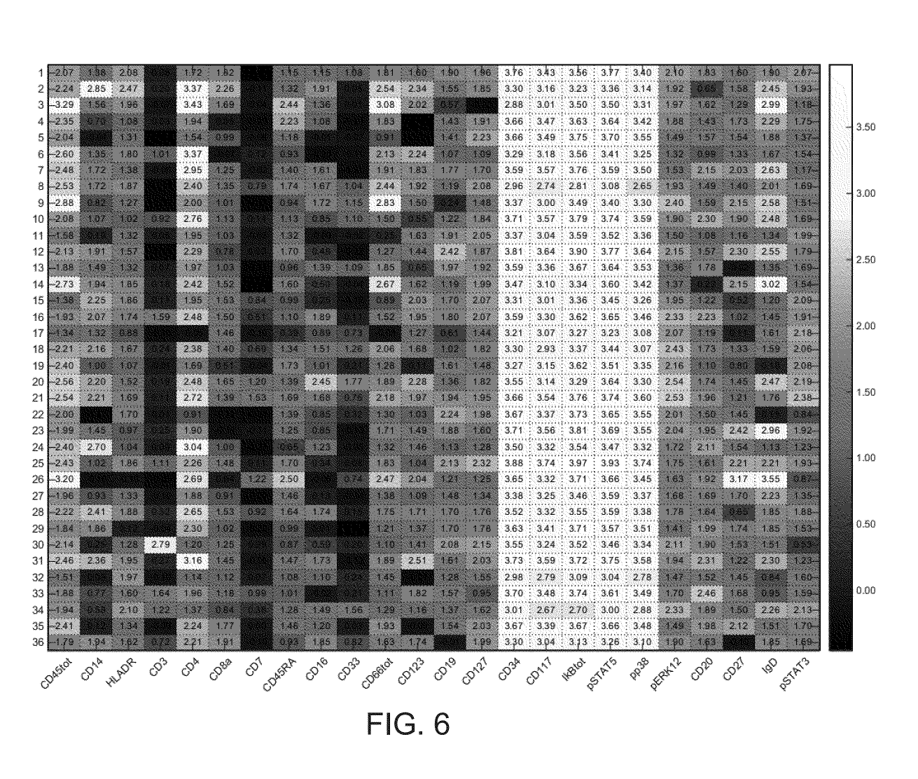

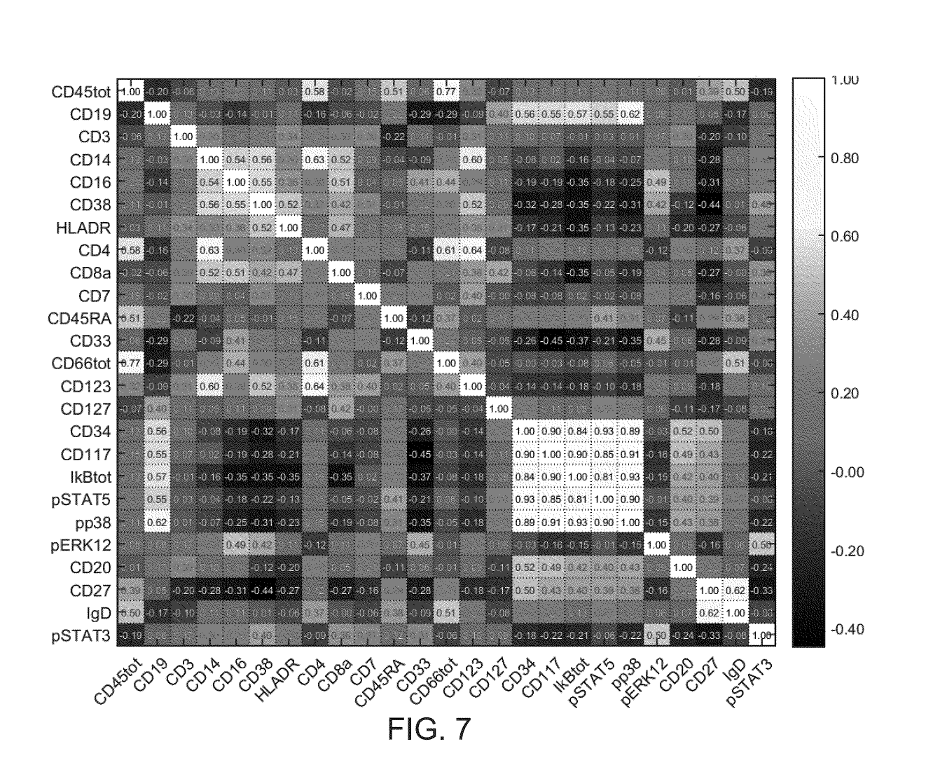

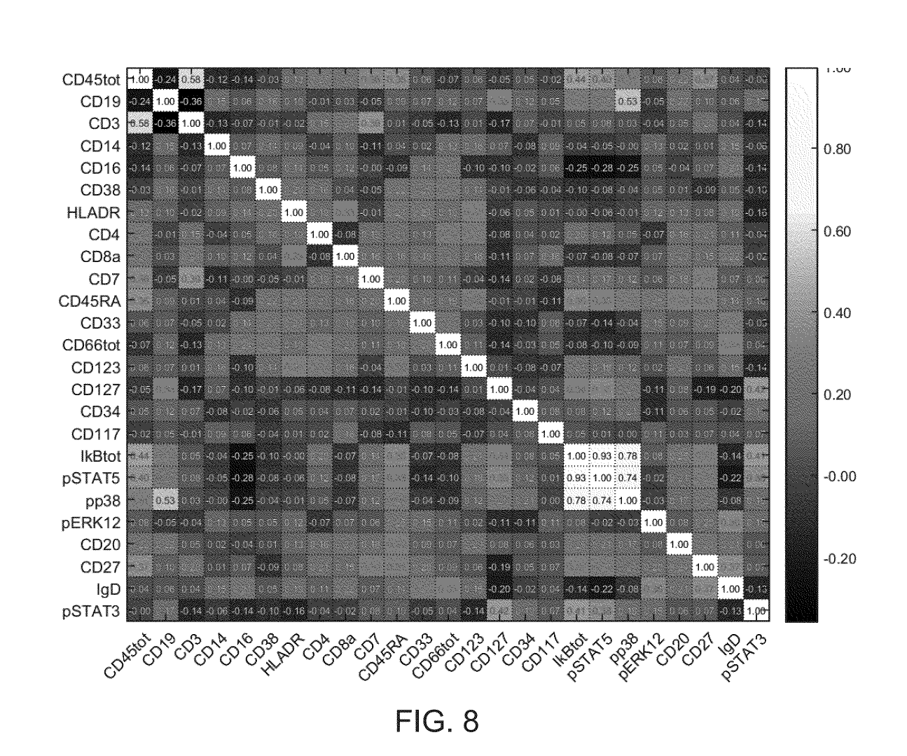

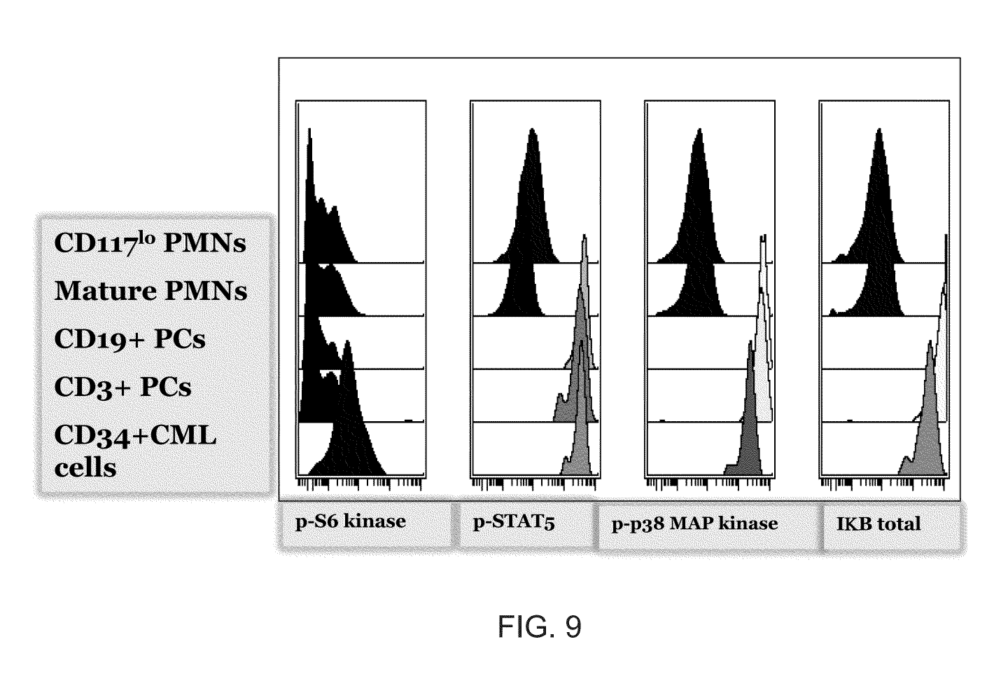

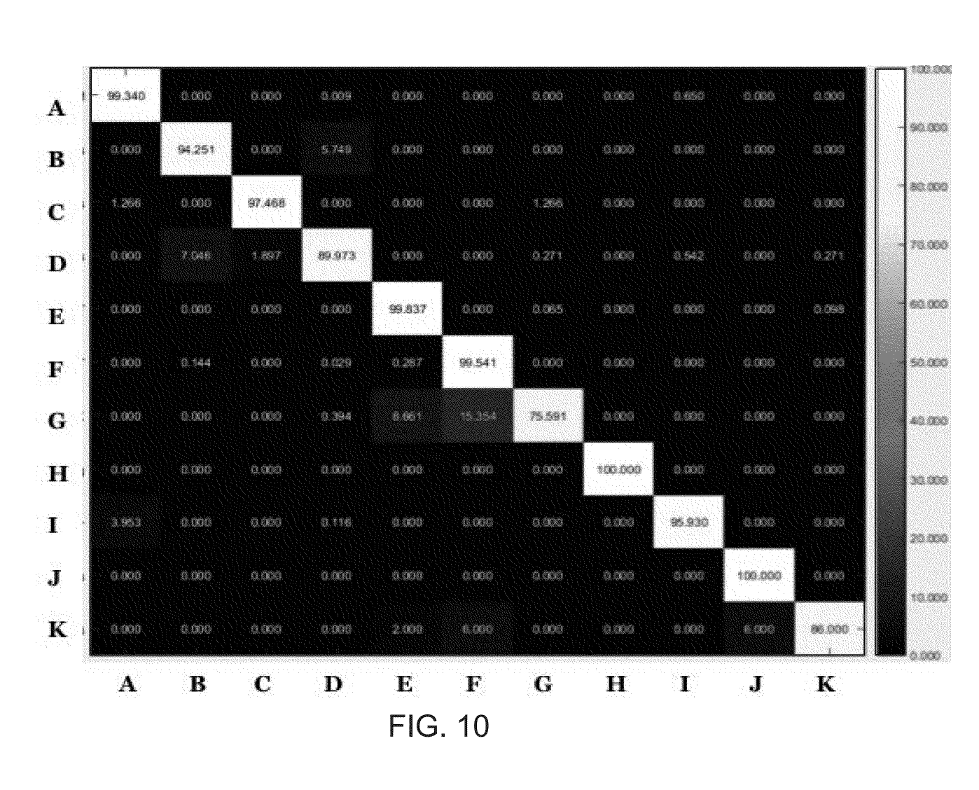

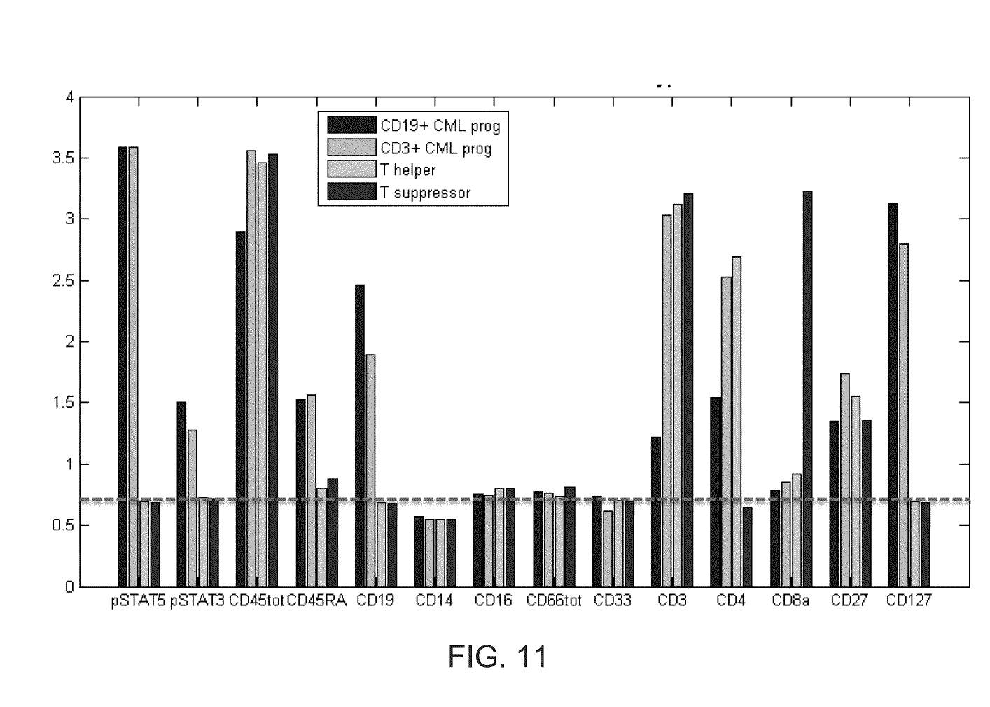

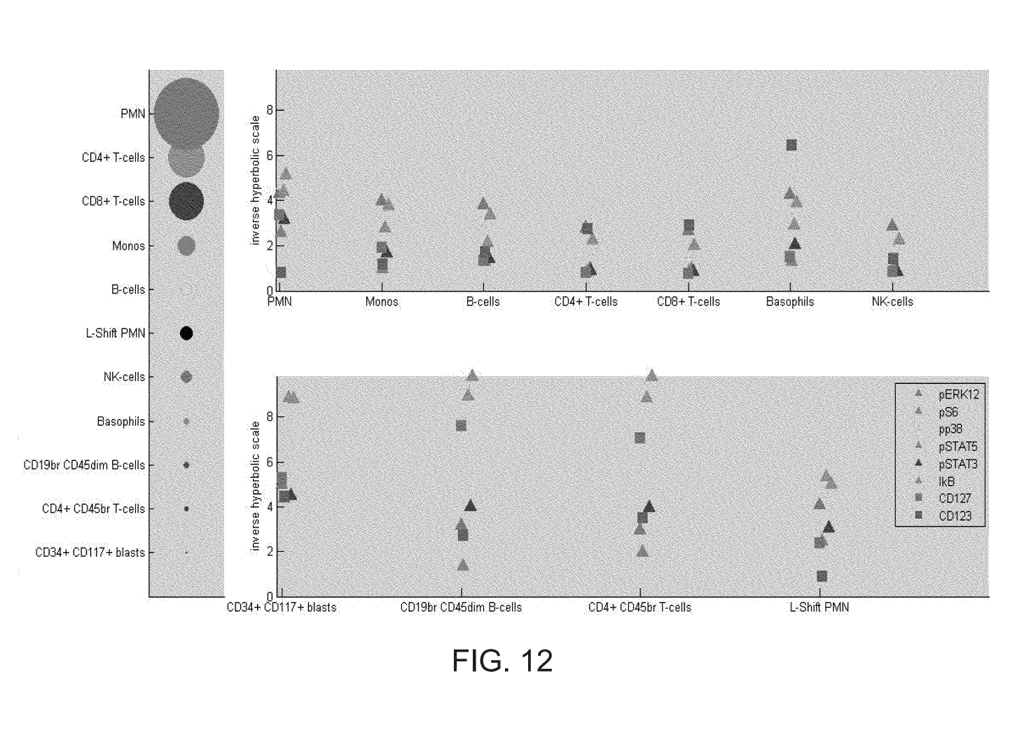

Methods and Results: The sample was fixed fresh and stained with a 30-Ab panel towards 24 surface markers and 6 intracellular (IC) phosphoproteins in a single tube phos-flow assay (Ref 1). Altogether, 3 p-STAT5^{hi} cell types (total <1%) were identifiable, with the CD34+ CML cells comprising 0.12% (i.e., 36 out of the total 30,579 events that passed the Eyelis™ data pre-processing and gating, FIGS. 6, 10, 12; Ref 2). Significant correlations between the expression of CD34, CD117, and certain IC phosphoproteins were identified in the CML cells (FIG. 7). The CD3+ and/or CD19+ lymphoid PCs expressed similar levels of p-STAT5 as the CD34+ cells, but ˜2×higher p-p38 MAPK (FIGS. 8,9). The CD3+ PCs overlapped phenotypically with CD19+ PCs, and mature T cell subsets (FIGS. 9 to 12). Few cells in transition between each of the CD19+/CD45^{lo} and the CD3+/CD45+ cell clusters and the CD34+/CD45^{lo} cells were observed (data not shown).

In this n=1 high parameter cytometry experiment, CML cells could be identified by Eyelis™ statistical pattern recognition of surface marker expression profile. In the context of previously diagnosed CML, the CD34+ cells likely represent cells that are precursors to maturing CML myeloid cells. Features distinguishing the CD19+ and/or CD3+ lymphoid PCs from the CD34+ CML cells include IL-7R expression, in addition to higher p38 MAP and absent S6 kinase activities. The phosphoprotein profile in IL-7R(+) lymphoid PCs bears partial resemblance with that in CD34+ CML cells, generating a pattern of cell-specific IC kinase activities, consistent with BCR-ABL reactivation upon stopping of TKI treatment. Immunophenotypic overlap between the CD19 and/or CD3 PCs can be explained by lineage plasticity and transitional states of cells arising from the CML stem cells.

Further study to assess the significance of different p-STAT5hi cell types will require identifying correlations between clinical outcomes and stem/progenitor cell type distributions and signaling activities, and the anti-leukemia immune response. The SCALPEL™ cell-based test designed with a limited panel of antibodies to identify cell types of prognostic relevance is a potential new way to quantify actionable residual/relapsed disease, and determine the cause of CML relapse (i.e. non-adherence/discontinuation v. on- and off-target resistance mechanisms).

Subtyping of progenitor cell types in CML after the initial (6-12 mo) treatment course that largely kills the mature neutrophils could be predictive in defining the subgroup of patients who can maintain treatment-free remission. The performance of Eyelis™ cell classification algorithms requires further optimization by training and testing on separate datasets.

While the above is a complete description of embodiments of the invention, various alternatives, modifications, and equivalents may be used. Therefore, the above description and the examples should not be taken as limiting the scope of the invention which is defined by the appended claims.

What is claimed is:

1. A device for classifying cells comprising:
a signal processor configured to automatically pre-process data from a mass cytometer configured to process data marked into a number of channels;
wherein pre-processing the data comprises performing the steps of:
a) identifying event values equal to or below a threshold value;
b) computing the mean and standard deviation of the identified event values;
c) using the computed mean and standard deviation to define a statistical distribution, wherein the statistical distribution comprises data>zero; and
d) replacing the event values equal to or below the threshold value in the marker channel with values drawn from the statistical distribution, wherein the replacement is not performed if a number of the event values is<3; and
wherein the signal processor is configured to independently perform steps a) through d) for each marker channel.

2. The signal processor of claim 1, wherein the statistical distribution is a Rician distribution, a Gaussian distribution, a Rayleigh distribution, or a Student's t-distribution.
